(19) United States
(12) Patent Application Publication
(10) Pub. No.: US 2025/0249853 A1
(43) Pub. Date: Aug. 7, 2025

(54) Modular Classic Grille Guard

(71) Applicant: Black Horse Off Road of GA, Inc., Royston, GA (US)

(72) Inventor: Fadi Ajam, Forest Hills, NY (US)

(73) Assignee: Black Horse Off Road of GA, Inc., Royston, GA (US)

(21) Appl. No.: 18/430,143

(22) Filed: Feb. 1, 2024

(51) Int. Cl. B60R 19/52

(52) U.S. Cl. CPC B60R 19/52

(57) ABSTRACT

A modified classic grille guard is configured with modularity, which may include, for example, seven distinct pieces instead of the conventional three. The middle portion of the grille guard is completely modular in that one or more crossbars are now detached from the opposing left and right side upright members. In the present scenario, the right and left brush guards are still one piece, but in other implementations, the brush guards could likewise be modular—i.e., their brush bars may be detached from their upright bars. The crossbars each attach to upright bars on each end of the crossbar, and in turn, the brush guards attach to the sides of the upright bar opposite the crossbars. Separation and modularity of these components reduce the structure's occupied space for packaging, storage, and transportation, thereby reducing backend costs.

### CROSS-REFERENCES TO RELATED APPLICATIONS

This Non-Provisional patent application is related to co-pending and co-filed patent application Ser. No. ______, filed contemporaneously herewith on Feb. 1, 2023, entitled “Modular Rugged Grille Guard,” the entire contents of which is hereby incorporated herein by reference.

### BACKGROUND

Vehicle accessories, such as grille guards attached to the front of a vehicle, are often assembled and delivered without sufficient regard for efficiency. For example, classic grille guards may come in three attachable components—the right and left brush guards and the crossbars. Users may deploy grille guards for aesthetics, to prevent more significant damage from collisions, and deflect oncoming debris, among other reasons. The two brush guards attach to opposing ends of the crossbars to create a secure unit. However, packaging, storing, and transporting such an assembly of components can be costly due to the overall girth of the assembled package, thereby occupying unnecessary real estate during storage and transportation and preventing larger numbers from being trafficked.

### SUMMARY

A modified and more refined classic grille guard separates the components to create a modular classic grille guard, which may include, for example, seven distinct pieces instead of the conventional three. The middle portion of the grille guard is completely modular in that one or more crossbars are now detached from the opposing left and right side upright members. In the present scenario, the right and left brush guards are still one piece, but in other implementations, they could likewise be modular—i.e., their brush bars may be detached from their upright bars.

Upon arrival at its destination, the user can assemble the middle guard such that the crossbars attach to each opposing left and right upright members, such as with a screw, bolts, nuts, etc. Once the middle guard is assembled, the user can attach the left and right brush guards to the middle guard's left and right upright members, thereby having a full assembly. Rubber, silicone, or other suitable inserts may be positioned between upright bars and the brush guards to prevent metal clanking during use. For example, the rubber inserts may be pre-installed via adhesive to one or both of the brush guard's or upright bar's surfaces. Thus, by making the classic middle guard modular, the consumer and manufacturer benefit from reduced packaging fees, transportation, etc. More units can be transported at a similar or lower price, also aiding in reduced environmental resources such as gas, pollution, etc.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of an assembled modular classic grille guard;

FIG. 2 shows an illustrative representation of the modular classic grille guard in an exploded fashion;

FIG. 3 shows an illustrative representation of a portion of the exploded classic grille guard from FIG. 2, showing additional components;

FIG. 4 shows an illustrative representation of a portion of the exploded classic grille guard;

FIG. 5 shows an illustrative representation of a rubber insert used with the classic grille guard;

FIG. 6 shows an illustrative representation of the plate's greater surface area, providing enhanced strength to the assembled modular grille guard; and

FIG. 7 shows an illustrative representation of packaging differences between a three-piece grille guard and a modular seven-piece grille guard.

Like reference numerals indicate like elements in the drawings. Elements are not drawn to scale unless otherwise indicated.

### DETAILED DESCRIPTION

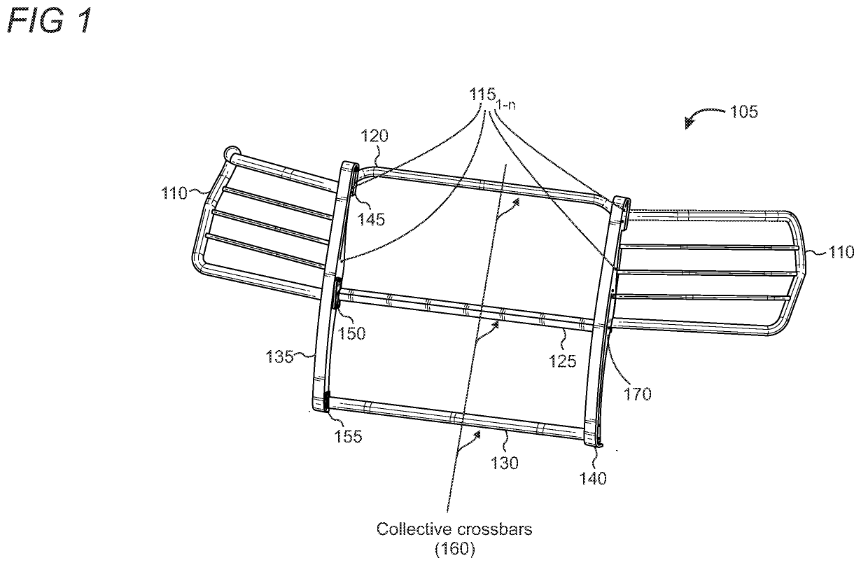

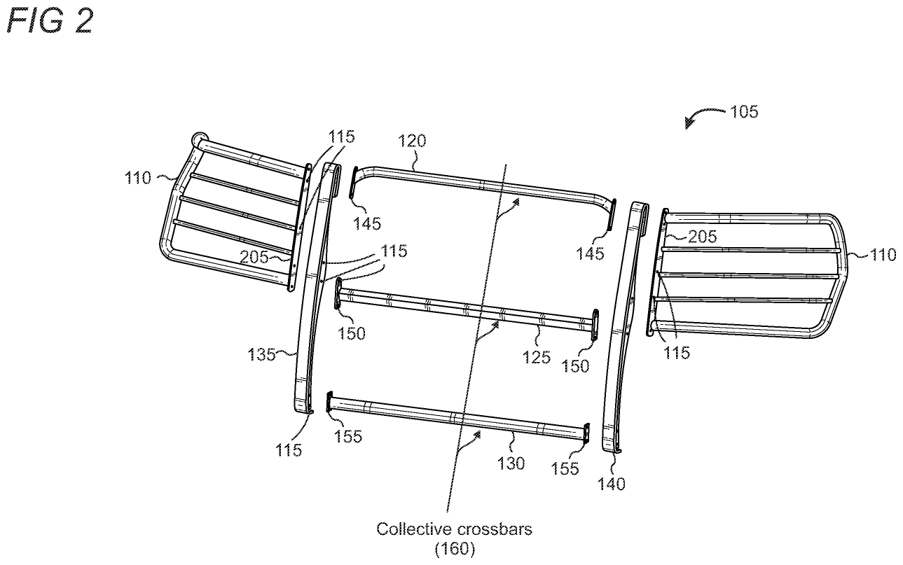

FIGS. 1 and 2 show illustrative representations of a modular grille guard 105 and an exploded view of the modular grille guard, respectively. Grille guards are typically attached on the front end of a truck for various reasons, including aesthetics, to enhance safety for passengers during collisions, to reduce damage to the truck's fenders, grille, and under-the-hood component (e.g., radiator, engine, etc.) during collisions, among other reasons. Users often purchase grille guards as an after-the-fact accessory for their vehicle and, therefore, may assemble and attach the grille guard themselves or hire a mechanic. The grille guard's components may typically be made of a metal material, but other materials, such as plastic or other suitable polymer, are also possible.

The modular grille guard 105 includes left and right brush guards 110 and various crossbars 160. References to “left” and “right” members, such as left brush guards, right brush guards, left upright bars, and right upright bars, are from the perspective of looking directly at the drawings as if looking at the vehicle, as opposed to being within the vehicle. As the grille guard 105 is substantially symmetrical, the left and right brush guards have been given the same reference numeral since their configurations are similar.

The left and right brush guards 110 attach to respective upright bars 135, 140 on opposite sides of the crossbars 160. The left and right brush guards include an elongated plate 205 that is used to engage with the upright bars, as discussed in greater detail below. The upright bars 135, 140 each have various holes 115 to enable screws or bolts to assemble the modular grille guard 105 together. The various crossbars 160, including upper crossbar 120, middle crossbar 125, and lower crossbar 130, each attaches to the upright bars 135 and 140 on their respective ends. Specifically, the crossbars 160 extend between the upright bars and form a mid-section of the grille guard when attached to a vehicle. While three crossbars are depicted in the drawings, in other implementations, any number of one or more crossbars may be used depending on the aesthetics and specific design of the grille guard.

Each crossbar includes plates that attach the crossbars to the respective upright bars 135, 140. Specifically, as shown in FIG. 2, the upper crossbar 120 includes plates 145, the middle crossbar includes plates 150, and the lower crossbar 130 includes plates 155. Each plate is on opposite ends of the crossbars and is used to attach to respective upright bars. The plates operate as strengthening components that provide a greater surface area to which the crossbars can attach to the upright bars. At least in some implementations, the plates are welded to the ends of the crossbars or are otherwise a single unitary piece with each crossbar to create enhanced strength. Since the crossbars are now modular to the upright bars, as opposed to being welded together at the factory or otherwise forming a single unitary component, adding the plates to the crossbars' ends functions as an additional strengthening layer so that the crossbars are attached to the upright bars at multiple locations. For example, the crossbars can attach at an upper and lower portion of the plates, thereby providing greater stability and strength.

In other implementations, the plates may be attached to the ends of the crossbars 160 via some fastening mechanism, such as a nut and bolt, tab and notch, screws, etc. For example, the plates may have a connector that inserts into a receptacle on the crossbars, and aligned holes on the plate or the connector aligns with holes on the crossbar's body to enable a user to insert a bolt, screw, etc. and attach the components.

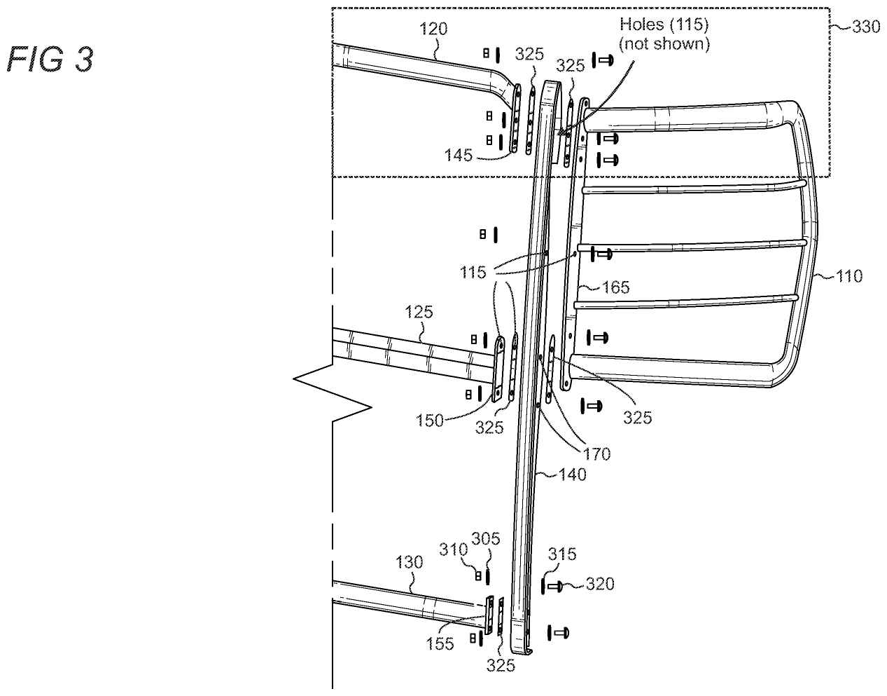

FIG. 3 shows an illustrative representation of the right brush guard 110 and the crossbars 160 aligned with and attaching to the right upright bar 140. As shown, the holes 115 throughout the various components align with each other to enable an integral connection. For example, the holes 115 on the upper crossbar 120 align with the holes on the right upright bar and the right brush guard so bolts 320 can engage through each component. Specifically, the bolts 320 enter through the right brush guard, through the right upright bar, and nuts 320 engage with the bolt on the other end of the upper crossbar. Washers 305 and 315 may also be used on the bolt's proximal and distal ends. Although the bolt is shown as inserted from the brush guard side, the bolt may alternatively enter from the crossbar side.

Also shown in FIG. 3 are protective inserts 325 placed between various connecting components. The inserts may be composed of rubber or other suitable material, such as latex, silicone, plastic, cloth, other suitable polymer, etc. The rubber functions as a buffer between the metal components to prevent, for example, unsettling and unappealing clanking while driving a vehicle, damage between components from banging if, for example, bolts are loosened, etc. The protective inserts are used at each side of the modular grille guard, such that the left side with the left brush guard, the left upright bar, and the left ends of the crossbars 160 may likewise utilize protective inserts 325. Thus, the drawings of the modular grille guard's right side represent the opposite left side as well, as the grille guard is substantially symmetrical in design and configuration.

As shown in FIG. 3, the inserts 325 may be designed to comport to the design of the crossbar plate to which it attaches. For example, the lower insert aligned with the lower plate 155 on the lower crossbar 130 forms a different shape than the plates above. In that regard, the lower plate's insert forms a shape that matches or substantially matches the plate's. Likewise, the protective inserts 325 on the middle and upper plates 150 and 145 comport with their shapes. In some implementations, the inserts may cover a surface area beyond the plates' perimeter to ensure that should any ruffling of the attached components occur, there is still no way for the metal plate to engage with the upright bar. Likewise, the inserts between the right brush guard and the right upright bar may also comport to the shape of the brush guard's elongated plate 205. For example, the insert may at least extend the full width or beyond the elongated plate's width to ensure that touching between components does not occur. The inserts may extend a distance above or below the holes 115, such as a centimeter, inch, multiple inches, etc. In other implementations, a single insert may extend fully across the elongated plate's body to ensure no metal from the brush guard can engage with the upright bar. Alternatively, the insert may extend slightly beyond the full perimeter of the elongated plate. In this regard, the single rubber insert may be pre-installed against the elongated plate's surface and have holes pre-drilled so a user can install the bolts.

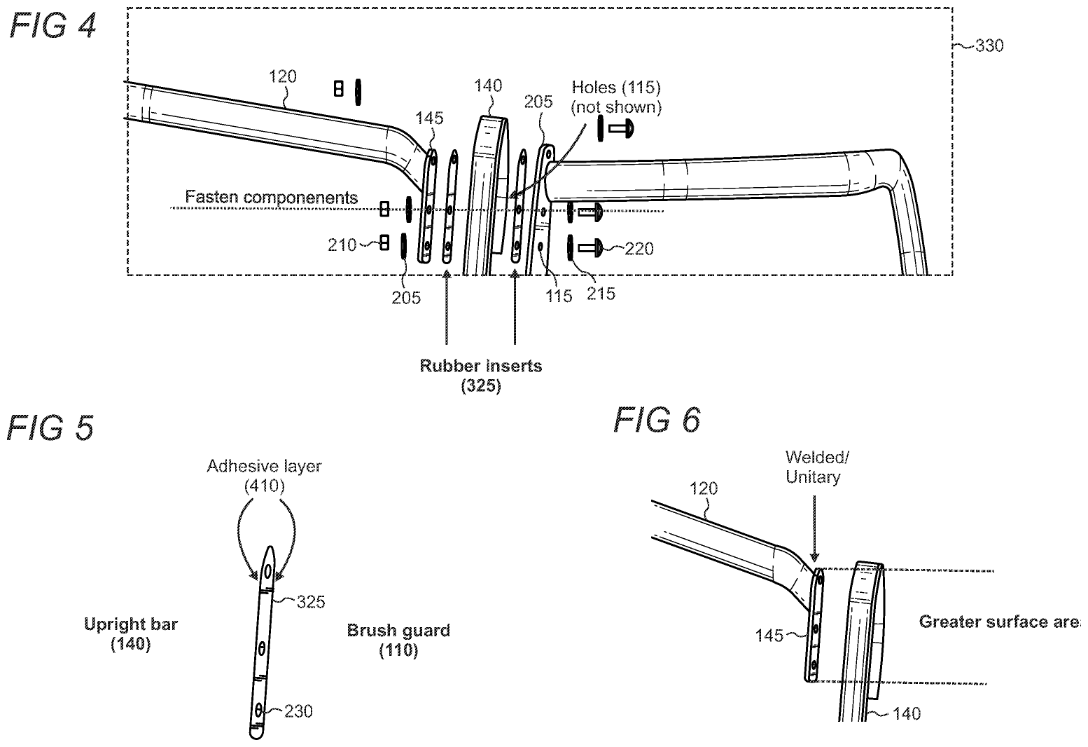

FIG. 4 shows an illustrative representation of the portion 330 shown in FIG. 3. As shown, the holes 115 on each component are aligned with each other to enable a unitary assembly. Specifically, a bolt 220 with washer 215 engages with holes on the elongated plate 205, through the first rubber insert 325 (between the upright bar and the right brush guard), the right upright bar 140, the second rubber insert 325 (between the upright bar and the upper crossbar 120), and the upper plate 145 on the upper crossbar 120. Multiple holes for each plate are utilized to create a more secure structure.

FIG. 5 shows an illustrative representation in which the inserts 325 may have adhesive on at least one side thereof so that the inserts are pre-installed to the modular grille guard 105. For example, the insert may have an adhesive layer 410 on the side of the plate 145, 150, or 155 to reduce the amount of user assembly. Alternatively, the adhesive may be on the side of the upright bar and pre-installed on the upright bar. In either case, the holes are pre-drilled into the inserts to make assembly easier. In some implementations, multiple inserts may be pre-installed on each component. For example, one insert may be pre-installed and attached against the crossbars' plates, and a second insert may be attached to the surface of the upright bar across from the plate, such that, when assembled, the inserts touch and engage with each other.

Similarly, depending on the construction, the inserts may be pre-installed against the elongated plate 205 or on the opposite side of the upright bar. Alternatively, inserts may be pre-installed against the elongated bar and the upright bar's surface directly across from the elongated plate, such that, when assembled, the two inserts engage with each other. Thus, in some implementations, up to four inserts may be used for a given segment (e.g., the upper crossbar segment) of the grille guard-two on the crossbar side and two on the brush guard side. In other implementations, a single insert that covers the entire outer surface of the elongated plate 205 may be pre-installed with pre-drilled holes to create a more seamless assembly.

FIG. 6 shows an illustrative representation in which the upper crossbar's plate 145 may be welded to the crossbar's elongated end structure to form a solid, unitary, and strong assembly. This way, any pressure resulting from the plate's connection to the right upright bar 140 is sufficiently secure. The greater surface area the plate provides strengthens the connection to the upright bar by, for example, preventing too much pressure against the crossbars' smaller width relative to the plate. While the classic grille guard can be configured without the plate such that the bolts can enter the tubes, overtime, the screws may come loose and/or too much pressure may be put against the tube structure and cause possible breakage. Furthermore, without the plate the screws may not be able to withstand the weight from the assembled structure. Overall, wear and tear may cause the structure to break, but utilizing the plate provides greater strength, stability, longevity. Although a welded embodiment is shown herein, in other implementations, the plate may be attached to the crossbar's end, such as via a bolt, screw, tab and notch, connect-receptacle, etc.

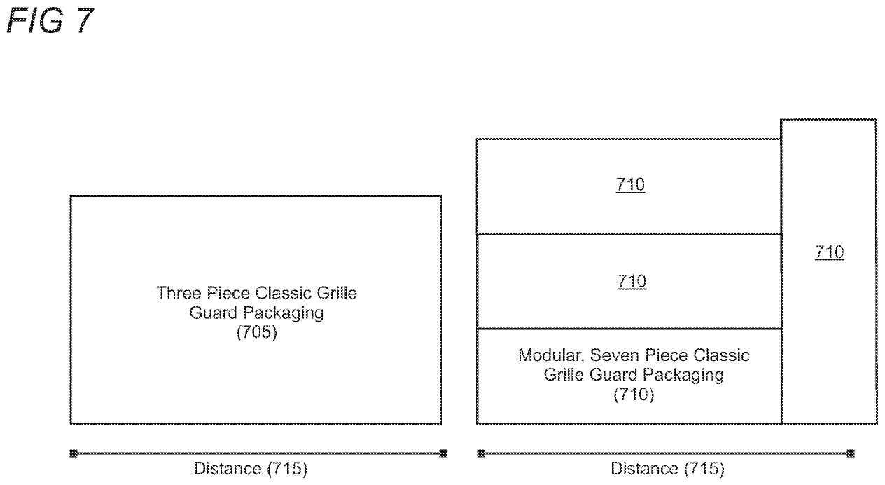

FIG. 7 shows an illustrative representation of the difference between the packaging for a three-piece classic grille guard 605 and the modular, seven-piece classic grille guard 710. A distance 715 is shown for comparison purposes between the two packaging sets. As shown, while a single distance enables the packaging of a single three-piece grille guard 705, with only a little more space in each direction, the user can ship up to four total units. On a mass scale of shipping hundreds of units, the cost savings may be cut by at least half and potentially as much as 75%. Such efficient packaging techniques are possible by creating a unique modular grille guard 105 as described above and shown with respect to FIGS. 1-6.

Various exemplary embodiments are disclosed herein. In one exemplary embodiment, disclosed is a modular grille guard, comprising: an initial brush guard that is initially detached from other components; an initial upright bar that is initially detached from other components; and one or more crossbars that are initially detached from at least the initial upright bar, wherein the one or more crossbars are attachable to the initial upright bar to form a secure assembly, and wherein the initial brush guard is attachable to the initial upright bar to form a secure assembly, in which the initial brush guard attaches to an opposite side of the initial upright bar relative to the one or more crossbars.

In another example, the initial brush guard and the one or more crossbars are attached to the initial upright bar using fasteners. As another example, the fasteners are nuts and bolts. In another example, a bolt extends from the initial brush guard's upright member, through the initial upright bar, and through a plate on a crossbar of the one or more crossbars to form a unitary assembly. In a further example, an insert positioned between the initial brush guard and the initial upright bar, wherein, when attached, the insert simultaneously touches surfaces of the initial upright bar and the initial brush guard. In a further example, an insert positioned between the initial upright bar and the crossbar of the one or more crossbars, wherein, when attached, the insert simultaneously touches surfaces of the initial upright bar and the crossbar. As another example, the inserts are rubber or silicone. As another example, the bolt further extends through the inserts. In another example, the plate on the crossbar of the one or more crossbars is welded to an end of the crossbar, and wherein the plate engages with greater surface area of the initial upright bar's surface to enhance strength of the assembled components.

In another exemplary embodiment, disclosed is a method of assembling a modular grille guard, comprising: providing an initial brush guard that is initially detached from other components; providing an initial upright bar that is initially detached from other components; providing one or more crossbars that are initially detached from at least the initial upright bar; attaching the one or more crossbars are to the initial upright bar to form a secure assembly, and attaching the initial brush guard is to the initial upright bar to form a secure assembly, in which the initial brush guard attaches to an opposite side of the initial upright bar relative to the one or more crossbars.

In another example, the initial brush guard and the one or more crossbars are attached to the initial upright bar using fasteners. As another example, the fasteners are nuts and bolts. As another example, a bolt extends from the initial brush guard's upright member, through the initial upright bar, and through a plate on a crossbar of the one or more crossbars to form a unitary assembly. As another example, an insert positioned between the initial brush guard and the initial upright bar, wherein, when attached, the insert simultaneously touches surfaces of the initial upright bar and the initial brush guard. In a further example, an insert positioned between the initial upright bar and the crossbar of the one or more crossbars, wherein, when attached, the insert simultaneously touches surfaces of the initial upright bar and the crossbar. In another example, the inserts are rubber or silicone. As another example, the bolt further extends through the inserts. In another example, the plate on the crossbar of the one or more crossbars is welded to an end of the crossbar, and wherein the plate engages with greater surface area of the initial upright bar's surface to enhance strength of the assembled components.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A modular grille guard, comprising:
an initial brush guard that is initially detached from other components;
an initial upright bar that is initially detached from other components; and
one or more crossbars that are initially detached from at least the initial upright bar,
wherein the one or more crossbars are attachable to the initial upright bar to form a secure assembly, and
wherein the initial brush guard is attachable to the initial upright bar to form a secure assembly, in which the initial brush guard attaches to an opposite side of the initial upright bar relative to the one or more crossbars.

2. The modular grille guard of claim 1, wherein the initial brush guard and the one or more crossbars are attached to the initial upright bar using fasteners.

3. The modular grille guard of claim 2, wherein the fasteners are nuts and bolts.

4. The modular grille guard of claim 3, wherein a bolt extends from the initial brush guard's upright member, through the initial upright bar, and through a plate on a crossbar of the one or more crossbars to form a unitary assembly.

5. The modular grille guard of claim 4, further comprising an insert positioned between the initial brush guard and the initial upright bar, wherein, when attached, the insert simultaneously touches surfaces of the initial upright bar and the initial brush guard.

6. The modular grille guard of claim 5, further comprising an insert positioned between the initial upright bar and the crossbar of the one or more crossbars, wherein, when attached, the insert simultaneously touches surfaces of the initial upright bar and the crossbar.

7. The modular grille guard of claim 6, wherein the inserts are rubber or silicone.

8. The modular grille guard of claim 7, wherein the bolt further extends through the inserts.

9. The modular grille guard of claim 5, wherein the plate on the crossbar of the one or more crossbars is welded to an end of the crossbar, and wherein the plate engages with greater surface area of the initial upright bar's surface to enhance strength of the assembled components.

10. A method of assembling a modular grille guard, comprising:
providing an initial brush guard that is initially detached from other components;
providing an initial upright bar that is initially detached from other components;
providing one or more crossbars that are initially detached from at least the initial upright bar;
attaching the one or more crossbars are to the initial upright bar to form a secure assembly, and
attaching the initial brush guard is to the initial upright bar to form a secure assembly, in which the initial brush guard attaches to an opposite side of the initial upright bar relative to the one or more crossbars.

11. The method of claim 10, wherein the initial brush guard and the one or more crossbars are attached to the initial upright bar using fasteners.

12. The method of claim 11, wherein the fasteners are nuts and bolts.

13. The method of claim 12, wherein a bolt extends from the initial brush guard's upright member, through the initial upright bar, and through a plate on a crossbar of the one or more crossbars to form a unitary assembly.

14. The method of claim 13, further comprising an insert positioned between the initial brush guard and the initial upright bar, wherein, when attached, the insert simultaneously touches surfaces of the initial upright bar and the initial brush guard.

15. The method of claim 14, further comprising an insert positioned between the initial upright bar and the crossbar of the one or more crossbars, wherein, when attached, the insert simultaneously touches surfaces of the initial upright bar and the crossbar.

16. The method of claim 15, wherein the inserts are rubber or silicone.

17. The method of claim 16, wherein the bolt further extends through the inserts.

18. The method of claim 14, wherein the plate on the crossbar of the one or more crossbars is welded to an end of the crossbar, and wherein the plate engages with greater surface area of the initial upright bar's surface to enhance strength of the assembled components.
